(19) United States
(12) Patent Application Publication
(10) Pub. No.: US 2021/0091928 A1
(43) Pub. Date: Mar. 25, 2021

(54) ITERATIVE CIPHER KEY-SCHEDULE CACHE FOR CACHING ROUND KEYS USED IN AN ITERATIVE ENCRYPTION/DECRYPTION SYSTEM AND RELATED METHODS

(71) Applicant: QUALCOMM Incorporated, San Diego, CA (US)

(72) Inventor: Kenneth Alan Dockser, Austin, TX (US)

(21) Appl. No.: 17/029,394

(22) Filed: Sep. 23, 2020

Related U.S. Application Data
(60) Provisional application No. 62/904,276, filed on Sep. 23, 2019.

(51) Int. Cl. H04L 9/06; H04L 9/08

(52) U.S. Cl. CPC H04L 9/0637; H04L 9/0894

(57) ABSTRACT

A key-schedule cache stores at least one key schedule based on a cipher key for data transformation using a block cipher. To obtain the round key for a data transformation, a key-word set, which may be a cipher key, including at least one round key is received in a round key control-circuit. The round key control-circuit determines whether the plurality of key words is already stored in the key-schedule cache and also determines whether the next round key, based on the key-word set, is also stored in the key-schedule cache. If the next round key is stored in the key-schedule cache, the round key control-circuit reads the next round key from the key-schedule cache and supplies the next round key to a next round key output. The round key control-circuit may also generate the next round key.

### PRIORITY CLAIM

The present application claims priority to U.S. Provisional Patent Application Ser. No. 62/904,276 filed on Sep. 23, 2019 and entitled “ITERATIVE CIPHER KEY-SCHEDULE CACHE FOR CACHEING CIPHER KEYS USED IN AN ITERATIVE ENCRYPTION/DECRYPTION SYSTEM AND RELATED METHODS,” the contents of which is incorporated herein by reference in its entirety.

### BACKGROUND

### I. Field of the Disclosure

The technology of the disclosure relates generally to iterative data encryption/decryption ciphers, such as the Advanced Encryption Standard (AES), for example, in a processor using iteratively generated round cipher keys.

### II. Background

Information security is vital to many types of computer-related processing activities, such as computerized financial services, legal transactions, and personal communications. These computerized activities often involve handling of private information which can then be at risk of exposure or hacking to unauthorized entities when the private information is transmitted and/or stored in digital form. One way to maintain security of information in a document that is transmitted or stored in digital form is to encrypt the information. The private information can then be retrieved by decrypting the information in an authorized manner. For example, to keep a document secure, an author can use a computer application executing on a processor to encrypt the document according to an encryption algorithm into an encrypted, unrecognizable form based on a cipher key created by the author. The cipher key is a string of data that is characterized by its length in bits. Subsequently, the encrypted document can be transformed back into its original readable form by employing the same cipher key and a corresponding decryption program. In this way, the information in the document is only available in unencrypted form to those individuals having access to the cipher key that was used to encrypt the document and knowledge of the encryption algorithm used for the encryption.

One type of encryption algorithm (“encryption scheme”) that can be used to encrypt a document is a block cipher. The document is divided into blocks, each having a particular number of words, and a block cipher is applied to transform each block into an encrypted block. An example of a block cipher is the Advanced Encryption Standard (AES). AES is an iterative block cipher or algorithm that receives a block of the original document (e.g., in binary form), and a cipher key and generates a first transformed block. A block is first transformed by the cipher key. Additional keys are generated from the cipher key using a key expansion algorithm. One of the generated keys is used in each round of further block transformations of the first transformed block. The keys used in each round are referred to as round keys, and a key schedule is comprised of the cipher key and all round keys generated from the cipher key. The key expansion algorithm can operate in a forward direction for encryption or a backward direction for decryption.

### SUMMARY OF THE DISCLOSURE

Aspects disclosed herein include an iterative cipher key-schedule cache for caching round keys used in an iterative encryption/decryption system. Related methods are also discussed. A block cipher is an algorithm used to encrypt a block of data in binary form into an unrecognizable form to prevent unauthorized access to the data. The algorithm includes a predetermined number of rounds of data transformation. The transformation begins in a first round using at least a portion of the cipher key and generates a new round key for each additional round. The round keys are generated from the cipher key using a key expansion algorithm. The complete set of round keys, including the cipher key, forms a key schedule. Since the same key schedule is employed for transforming (i.e., encrypting and/or decrypting) every data block of a document, the key schedule is used repeatedly. In some implementations, the key schedule is not stored for security reasons so the entire key schedule is regenerated from the cipher key each time a new block is transformed, wasting processor capacity and power. In other implementations, the round keys are stored in memory requiring frequent memory operations to access the round keys. In yet other implementations, the round keys are kept in the register file, occupying a limited processor resource.

An exemplary key-schedule cache is employed for storing at least one key schedule based on a cipher key for data transformation using a block cipher. To obtain the round key for a data transformation, a plurality of key words, or a key-word set, including at least one round key are received in a round key control-circuit. The key-word set may, for example, be a cipher key. The round key control-circuit determines whether the plurality of key words is already stored in the key-schedule cache and also determines whether the next round key, based on the key-word set, is also stored in the key-schedule cache. If the next round key is stored in the key-schedule cache, the round key control-circuit reads the next round key from the key-schedule cache. In one example, if the key-word set is not stored in the key-schedule cache, the round key control-circuit generates the next round key. In another example, if the key-word set is stored in the key-schedule cache, but the next round key is not stored in the key-schedule cache, the round key control-circuit generates the next round key. The next round key, whether it is read from the key-schedule cache or generated, is supplied, for example, to an encryption/decryption engine for the next round of data transformation according to the block cipher.

In this regard, in exemplary aspects disclosed herein, a round key control-circuit is disclosed. The round key control-circuit is configured to store at least one key schedule comprising round keys, each round key corresponding to a data transformation round of a block cipher and comprising a plurality of key words. The round key control-circuit is also configured to receive a key-word set comprising a plurality of key words of a key schedule, the key-word set comprising at least one round key, and determine whether the key-word set is stored in a key-schedule cache. In response to determining the key-word set is stored in the key-schedule cache, the round key control-circuit is also configured to determine whether a next round key, based on the key-word set, is stored in the key-schedule cache, and, in response to determining the next round key is stored in the key-schedule cache, read the next round key from the key-schedule cache. The round key control-circuit is further configured to supply the next round key to a next round key output.

In another exemplary aspect, a method of a round key control-circuit is disclosed. The method comprises storing at least one key schedule comprising round keys, each round key corresponding to a data transformation round of a block cipher and comprising a plurality of key words. The method includes receiving a key-word set comprising a plurality of key words of a key schedule, the key-word set comprising at least one round key, and determining whether the key-word set is stored in a key-schedule cache. The method also includes, in response to determining the key-word set is stored in the key-schedule cache, determining whether a next round key, based on the key-word set, is stored in the key-schedule cache. The method also includes reading the next round key from the key-schedule cache in response to determining the next round key is stored in the key-schedule cache. The method also includes supplying the next round key to a next round key output.

In another exemplary aspect, a processor circuit comprising a key-schedule cache and a round key control-circuit is disclosed. The round key control-circuit is configured to store at least one key schedule in the key-schedule cache, the at least one key schedule comprising round keys, each round key corresponding to a data transformation round of a block cipher and comprising a plurality of key words. The round key control-circuit is also configured to receive a key-word set comprising a plurality of key words of a key schedule, the key-word set comprising at least one round key, and determine whether the key-word set is stored in the key-schedule cache. The round key control-circuit is also configured to, in response to determining the key-word set is stored in the key-schedule cache, determine whether a next round key, based on the key-word set, is stored in the key-schedule cache. The round key control-circuit is also configured to, in response to determining the next round key is stored in the key-schedule cache, read the next round key from the key-schedule cache. The round key control-circuit is further configured to supply the next round key to a next round key output.

### BRIEF DESCRIPTION OF THE FIGURES

FIG. 1 is a flowchart illustrating data encryption and decryption rounds performed by an encryption/decryption engine based on an block cipher, such as the Advanced Encryption Standard (AES) to encrypt/decrypt (“transform”) a block of data using a key schedule based on a cipher key;

FIG. 2 is a flowchart illustrating operations performed by the encryption/decryption engine in individual encryption and decryption rounds illustrated in FIG. 1;

FIG. 3 illustrates a cipher key array and a key schedule generated from the cipher key based on a key expansion algorithm for use in the encryption rounds illustrated in FIGS. 1-2;

FIG. 4 illustrates operations of a key expansion engine for generating pluralities of key words of a key schedule illustrated in FIG. 3 from a cipher key in a sequence according to an AES key expansion scheme;

FIG. 5 is a schematic diagram of an exemplary round key control-circuit in an encryption/decryption system configured to store at least one key schedule including a cipher key and round keys generated based on the cipher key, and supply a next round key stored in the key-schedule cache to a processor to avoid wasting processor capacity and power consumption required to regenerate round keys of the key schedule from the same cipher key;

FIG. 6 is a flowchart illustrating an exemplary process of the round key control-circuit in FIG. 5 for receiving a round key request and supplying generated round keys of a key schedule for a block cipher to avoid regenerating the key schedule for each block transformed with the same cipher key;

FIG. 7 is a schematic diagram of an alternative to the exemplary round key control-circuit in FIG. 5, in which the key-schedule cache includes a cipher key storage configured to store cipher keys, and a generated round key storage configured to store previously generated round keys of a key schedule based on the cipher keys stored in the cipher key storage;

FIG. 8 is a block diagram of an exemplary processor-based system that can include an integrated circuit (IC) with a round key control-circuit in an encryption/decryption system configured to store at least one key schedule including a cipher key and round keys generated based on the cipher key, and supply a next round key stored in the key-schedule cache to a processor to avoid wasting processor capacity and power consumption required to regenerate round keys of the key schedule from the same cipher key, such as the round key control-circuit in FIGS. 5 and 7; and

FIG. 9 is a block diagram of an exemplary wireless communications device that includes radio frequency (RF) components formed from an IC, wherein any of the components therein can include an IC with a round key control-circuit in an encryption/decryption system configured to store at least one key schedule including a cipher key and round keys generated based on the cipher key, and supply a next round key stored in the key-schedule cache to a processor to avoid wasting processor capacity and power consumption required to regenerate round keys of the key schedule from the same cipher key, such as the round key control-circuit in FIGS. 5 and 7.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed herein include an iterative cipher key-schedule cache for caching round keys used in an iterative encryption/decryption system. Related methods are also discussed. A block cipher is an algorithm used to encrypt a block of data in binary form into an unrecognizable form to prevent unauthorized access to the data. The algorithm includes a predetermined number of rounds of data transformation. The transformation begins in a first round using at least a portion of the cipher key and generates a new round key for each additional round. The round keys are generated from the cipher key using a key expansion algorithm. The complete set of round keys, including the cipher key, forms a key schedule. Since the same key schedule is employed for transforming (i.e., encrypting and/or decrypting) every data block of a document, the key schedule is used repeatedly. In some implementations, the key schedule is not stored for security reasons so the entire key schedule is regenerated from the cipher key each time a new block is transformed, wasting processor capacity and power. In other implementations, the round keys are stored in memory requiring frequent memory operations to access the round keys. In yet other implementations, the round keys are kept in the register file, occupying a limited processor resource.

An exemplary key-schedule cache is employed for storing at least one key schedule based on a cipher key for data transformation using a block cipher. To obtain the round key for a data transformation, a plurality of key words, or a key-word set, including at least one round key are received in a round key control-circuit. The key-word set may, for example, be a cipher key. The round key control-circuit determines whether the plurality of key words is already stored in the key-schedule cache and also determines whether the next round key, based on the key-word set, is also stored in the key-schedule cache. If the next round key is stored in the key-schedule cache, the round key control-circuit reads the next round key from the key schedule. In one example, if the key-word set is not stored in the key-schedule cache, the round key control-circuit generates the next round key. In another example, if the key-word set is stored in the key-schedule cache, but the next round key is not stored in the key-schedule cache, the round key control-circuit generates the next round key. The next round key, whether it is read from the key-schedule cache or generated, is supplied, for example, to an encryption/decryption engine for the next round of data transformation according to the block cipher.

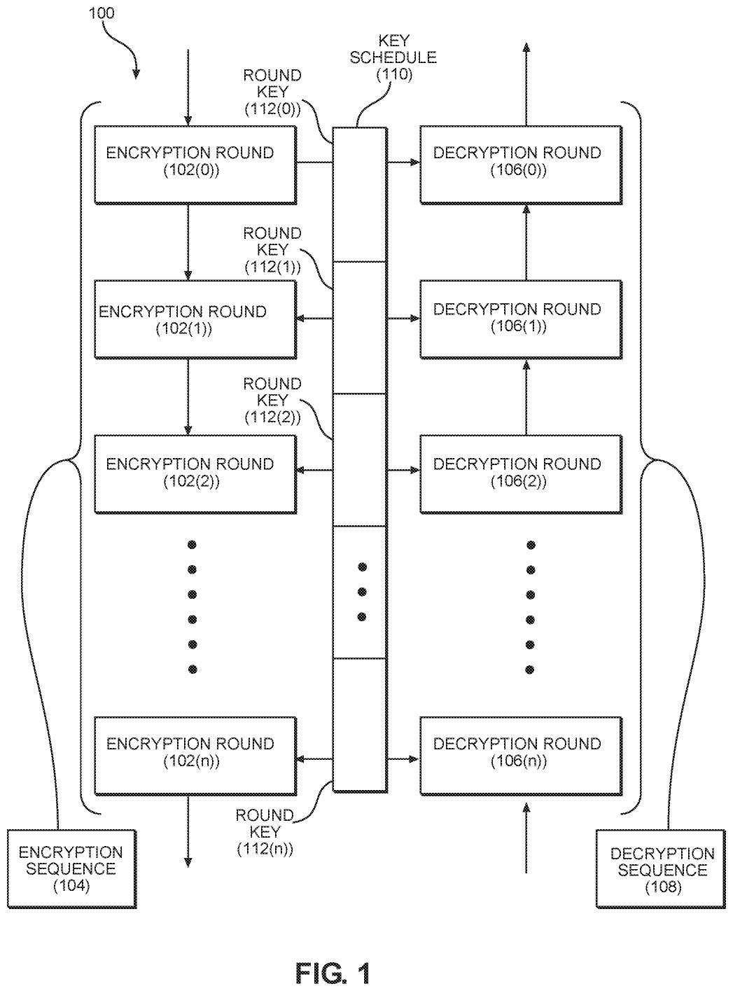

Before discussing exemplary iterative encryption/decryption systems that include a round key control-circuit employing an iterative cipher key-schedule cache for storing (i.e., caching) and supplying a previously generated round key of a key schedule for transforming a data block, the iterative Advanced Encryption Standards (AES-128, AES-192, and AES-256) are first discussed with regard to FIGS. 1-4 for context. The AES encryption/decryption schemes are block ciphers that iteratively transform data blocks of a document in binary form to encrypt or decrypt the document. Each data block is transformed in multiple rounds of operations that each employ a respective key used to operate on an input data block. In the first round, the input data block is the original binary data of a document, and the round key is at least a portion of a cipher key. The cipher key is a plurality of binary data words (“key words”) from a key provided by a document owner, for example. In the next (i.e., second) round, the data block transformed in the first round is the input data block to the second round. A next round key for the second round is generated from the key words of the cipher key, depending on the particular AES employed, and based on a key generation algorithm.

In the example of AES-128, the first round key, which is the cipher key, is 128 bits, the next round key is a 128 bit key generated from the cipher key, and all subsequent keys are 128 bit keys generated from a previous key. In AES-192, the cipher key contains the first round key (128 bits) and half (64 bits) of the second round key. The remainder of the second round key is generated based on the cipher key. In AES-256, the cipher key of 256 bits includes the first round key and the second round key of 128 bits each. Subsequent keys are generated based on the cipher key. In each subsequent round, the data block input is the transformed data from the previous data transformation round, and the key used for data transformation is generated from previous round keys.

As noted, in each of AES-128, AES-192, and AES-256, a 128 bit round key is used to perform data transformation in each round. However, the 128 bits, or four (4) words of the round keys are generated in different manners. In AES-128, the cipher key is a first 128 bit (4 word) round key used in the first data transformation round. Using a key expansion algorithm, the second 128 bit round key is generated from the first 128 bit round key, and the third 128 bit round key is generated from the second 128 bit round key, and so on. Thus, each of the round keys in the key schedule is based on the cipher key.

In AES-192, the cipher key is 192 bits or a six (6) key-word set. Although the key words are taken 4 at a time as round keys, the corresponding key expansion algorithm generates additional key words of the key schedule 6 key words at a time from the cipher key and continues to generate a next 6 key words from the previous 6 key words. In AES-256, the cipher key is 256 bits or an eight (8) key-word set, which includes 4 key words for the first round key used in the first data transformation round and 4 words for the second round key used in the second data transformation round. The corresponding key expansion algorithm generates 8 more key words from the cipher key and continues to generate 8 key words of the key schedule 8 at a time. Herein, the term “key-word set” will be used to refer to a plurality of key words of a cipher key or another plurality of key words of a same size as a cipher key and generated as a set in the key expansion algorithm. Thus, the key-word sets for AES-128, AES-192, and AES-256 are 4 key words, 6 key words, and 8 key words, respectively.

While the inventive aspects disclosed herein are described with reference to block ciphers AES-128, AES-192, and AES-256, the present disclosure and claims are not limited in this regard and are understood to be applicable to other iterative block ciphers.

FIG. 1 is a flowchart 100 illustrating encryption rounds 102(0)-120(n) of an AES block encryption scheme (“encryption sequence”) 104. In each of the encryption rounds 102(0)-102(n), a key and a data block are received, and an encrypted. data block is generated. FIG. 1 also shows decryption rounds 106(n)-106(0) of an AES data block decryption scheme (“decryption sequence”) 108. As noted above, AES may be implemented with different key lengths (i.e., 128, 192, or 256 bits). The number of rounds (n+1) varies according to the key length. For example, AES encryption using a 128 bit key consists of eleven (11) rounds. In this example, the AES encryption sequence 104 may include encryption rounds 102(0)-102(10) (e.g., “n”=10), and the corresponding AES decryption sequence 108 may include decryption rounds 106(10)-106(0). In this example, a key schedule 110 includes ten (10) generated round keys 112(1)-112(10), each 128 bits in length and generated successively from a 128 bit cipher key, which is the first round key 112(0). In the AES decryption sequence 108, the round keys 112(0)-112(n) are used in the decryption rounds 106(n)-106(0) in reverse order compared to the encryption sequence 104. In other words, the AES decryption sequence 108 begins with decryption round 106(n) using round key 112(n), and the last decryption round 106(0) uses the cipher key (round key 112(0)).

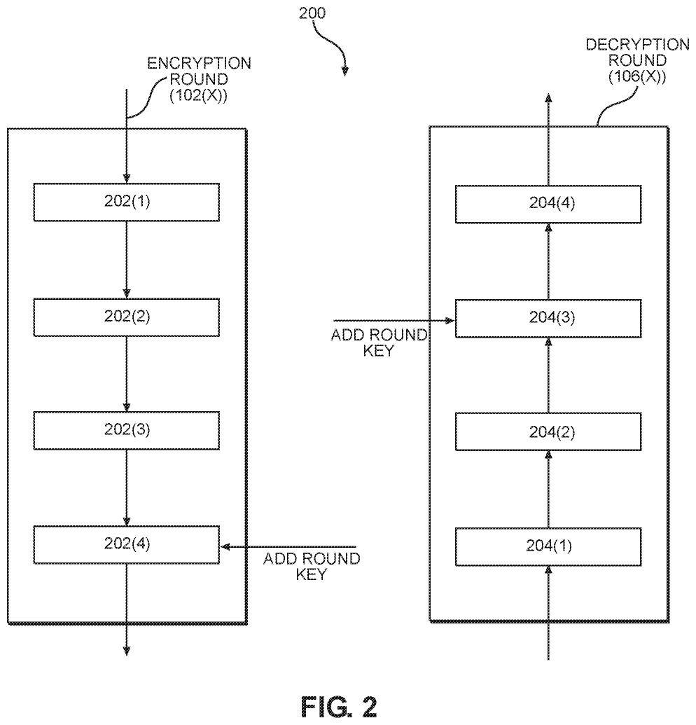

FIG. 2 is a flowchart 200 illustrating a set of operations 202(1)-202(4) performed in any encryption round 102(x) (where x=1 to n−1) in the AES encryption sequence 104 in FIG. 1. Each of such rounds includes a “Substitute Bytes” operation 202(1), a “Shift Rows” operation 202(2), a “Mix Columns” operation 202(3), and an “Add Round Key” operation 202(4). The operations performed in encryption rounds 102(0) and 102(n) of the AES encryption sequence 104 differ from those of encryption rounds 102(1)-102(n−1), and will not be described further here, but all of the encryption rounds 102(0)-102(n) receive a block of data and a key and generate encrypted data. FIG. 2 also illustrates a set of operations 204(1)-204(4) performed in a decryption round 106(x), where x=n−1 to 1 in the decryption sequence 108. Each of these rounds includes an “Inverse Shift Rows” operation 204(1), an “Inverse Substitute Keys” operation 204(2), an “Add Round Key” operation 204(3), and an “Inverse Mix Columns” operation 204(4). The operations performed in decryption rounds 106(0) and 106(n) of the AES decryption sequence 108 differ from those of decryption rounds 106(1)-106(n−1), and will not be described further here, but all of the decryption rounds 106(0)-106(n) receive an encrypted block of data and a key and generate decrypted data. Additional details of the AES encryption sequence 104 and decryption sequence 108 are publicly available and not described in further detail here.

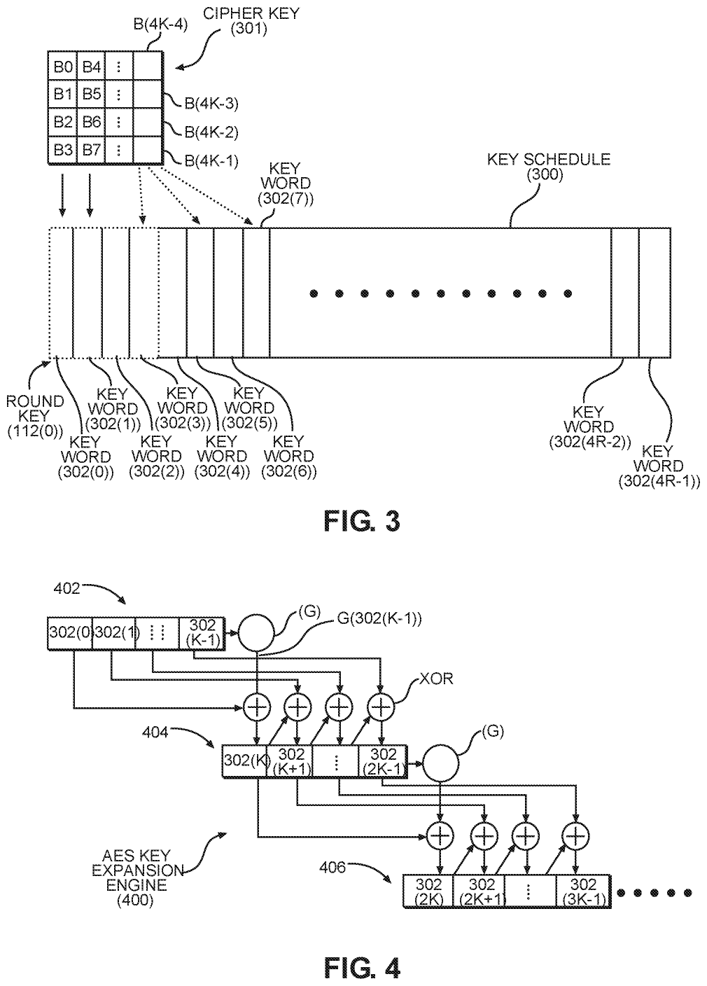

FIG. 3 illustrates a key schedule 300 generated from a cipher key 301, based on a key expansion algorithm for the corresponding block cipher. The cipher key 301 includes the first round key 112(0) for use in the encryption round 102(0). The remaining round keys 112(1)-112(n) (not shown) are generated from the cipher key 301 for using in the remaining encryption rounds 102(1)-102(n) of the encryption sequence 104 and in decryption rounds 106(n)-106(0) of the decryption sequence 108. FIG. 3 illustrates the cipher key 301 as an array of bytes B0-B(4K−1), where K is the number of key words (4, 6, or 8) in the cipher key 301 depending on the block ciphers AES-128, AES-192, and AES-256, respectively. The round key 112(0) may be formed of four (4) 32-bit words (key words 302(0)-302(3)) each consisting of four (4) bytes (i.e., 8 bits) of the cipher key 301. In AES-128, for example, one of the round keys 1112(1)-112(10) is generated for each of the encryption rounds 102(1)-102(10), to produce a key schedule 300 consisting of a total of 44 key words 302(0)-302(43). In AES-192, the round key 112(0) is the first 4 words of the cipher key 301, which includes six (6) 32-bit words (key words 302(0)-302(5)), and in AES-256 the cipher key 301 includes eight (8) 32-bit words (key words 302(0)-302(7)) including the first and second round keys 112(0)-112(1).

FIG. 4 illustrates the operations of an AES key expansion engine 400 consistent with the AES-128 and AES-192 algorithms. Operation of the AES key expansion engine 400 begins by receiving a cipher key 402, generating a first key-word set 404 from the cipher key 402, and generating a second key-word set 406 from the first key-word set 404. The cipher key 402 may be the cipher key 301 and includes key words 302(0)-302(K−1), where K is the number of key words in a cipher key. As shown, the key words 302(K)-302(2K−1) are generated from the cipher key 402 and key words 302(2K)-302(3K−1) are generated from the key words 302(K)-302(2K−1), and so on. A function (G) is applied to key word 302(K−1), and the result G(302(K−1)) is exclusively-ORed (XORed) with key word 302(0) to generate key word 302(K). As shown, key words 302(K+1) through 302(2K−1) are generated through a sequence of operations, which continues to key word 302(4R−1) (see FIG. 3), where “R” is the number of rounds in a block cipher.

To generate the entire key schedule 300, which may he discarded immediately after a block is transformed, the large number of required operations illustrated in part in FIG. 4 consume many processing cycles and a significant amount of power. if the same key schedule 300 is immediately needed again to process the next data block of a document for encryption or decryption, the processing cycles and power consumption could be saved by storing the key schedule 300.

The instruction architecture of a processing circuit (“processor”) may include encryption/decryption (enc/dec) instructions available to a programmer for performing a data transformation as part of a programmed application. In one example, each enc/dec instruction may cause the processor to perform a single round (i.e., a “single round instruction”) of transformation on a data block. Therefore, prior to executing the enc/dec instruction, a round key request instruction must be issued to obtain the appropriate round key for the transformation round. In this method, a round key request instruction is issued for each round. However, generating a round key every time it is used wastes processor cycles and power. Storing round keys in memory creates a security risk, and temporarily saving the round keys in a register file limits the fast temporary storage available to the processor for operands.

Alternatively, an instruction architecture of a processor may include an enc/dec instruction to perform all rounds (i.e., an “all rounds instruction”) of a block cipher, such as the encryption sequence 104 and the decryption sequence 108 in FIG. 1. When an all rounds enc/dec instruction is executed, the processor or encryption engine can execute all the iterative transformation rounds in a manner that is transparent to the programmer. A round key corresponding to each of the R transformation rounds would he needed by the processor or encryption engine. A related all rounds round key request instruction may be employed to obtain the round keys individually in sequence.

Other variations of enc/dec instructions are also possible, such as instructions for executing a number of rounds but less than all rounds. In accordance with such instructions, other variations of round key request instructions would be issued within the processor.

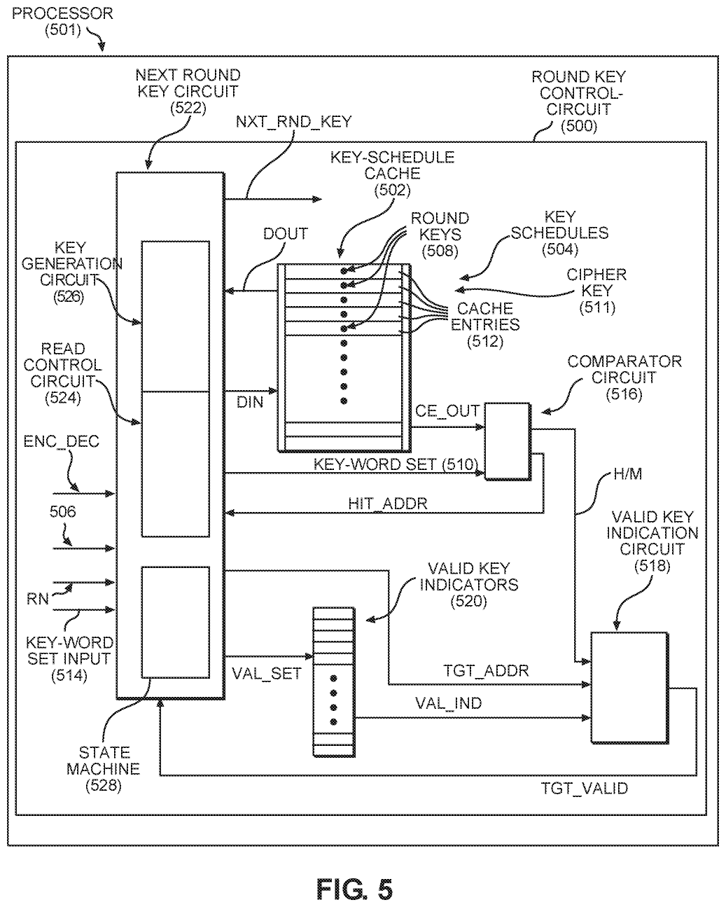

FIG. 5 is a schematic diagram of an exemplary round key control-circuit 500 in a processor or iterative encryption/decryption system (“processor”) 501. As shown in FIG. 5, the round key control-circuit 500 includes a key-schedule cache 502 configured to store at least one key schedule 504. in an alternative example, the key-schedule cache 502 may be external to the round key control-circuit 500. A round key request instruction 506 (also referred to herein as a “request instruction 506”) includes a request for a next round key 508 or a portion (e.g., half) of the next round key 508. The request instruction 506 can be received on a dedicated serial or parallel interface, or a shared system bus, etc. In one example, the round key control-circuit 500 receives a key-word set 510 in association with the round key request instruction 506. Key-word sets 510 are generated according to a key expansion algorithm corresponding to a block cipher. A key-word set 510 is created from a cipher key 511 and sized according to the block cipher. The key schedule 504 consists of key-word sets 510 beginning with the cipher key 511 and the remaining key-word sets 510 are generated in sequence starting from the cipher key 511. In the key-schedule cache 502 in FIG. 5, the cipher key 511 may be stored in any one or more of the cache entries 512. In one example, the remaining key-word sets 510 of the key schedule 504 may be stored as they are created in sequential cache entries 512. adjacent to the cipher key 511. A key-word set 510 is a set of key words (e.g., 32 bits per word) equal in size to a cipher key 511 (i.e., same number of key words, depending on the block cipher), and the key-word set 510 received with the round key request instruction 506 may be the cipher key 511. The key expansion algorithm corresponding to the block cipher may be determined by the size (e.g., number of key words) of the received key-word set 510 or may be determined based on the round key request instruction 506 or a parameter included in the round key request instruction 506. The cipher key 511 may be provided to identify the key-schedule cache 502. Alternatively, the key-word set 510 received in association with the round key request instruction 506 may be the key-word set 510 immediately preceding the key-word set 510 containing the requested next round key 508 or a portion of the requested next round key 508 (or portion thereof). The key-word set 510 may be provided separate from the request instruction 506 or on a same interface.

While the cipher key 511 and the rest of the key schedule 504 are kept in the key-schedule cache 502, they are kept secure by virtue of the fact that the only way to read the round keys 508 from the key-schedule cache 502 is to supply all of the information necessary to generate them. The key-schedule cache 502 may be viewed as a black box that speeds up subsequent generations of the key schedule 504 after it is initially generated, to reduce power consumption. Unlike storing the round keys 508 in registers, traditional caches, or memory, the key-schedule cache 502 does not store the round keys 508 in insecure locations, where they might be accessed in a manner that is not intended.

The round key control-circuit 500 is configured to securely store a key schedule 504 including a cipher key 511 and other key-word sets 510, which are generated from the cipher key 511. If a key schedule 504 based on a cipher key 511 is stored in the key-schedule cache 502, and the same cipher key 511 is subsequently employed by the processor 501 to encrypt or decrypt additional data blocks, it is not necessary to regenerate the key schedule 504 for each data block. Round keys 508 that are requested but not present in the key-schedule cache 502 are generated and may be stored in the key-schedule cache 502 until they are purged, over-written, or invalidated, for example.

With continued reference to FIG. 5, the round key control-circuit 500 includes the key-schedule cache 502 including a plurality of cache entries 512 to store round keys 508 of a key schedule 504. Each round key 508 stored in a cache entry 512 corresponds to a data transformation round of a block cipher. A round key 508 stored in the key-schedule cache 502 may have been received in a cipher key 511 or other key-word set 510 received in association with the request instruction 506. The cipher key 511 or other key-word set 510 is received on a key-word set input 514. A stored round key 508 may also have been generated from the received cipher key 511 or another key-word set 510, or generated from another key-word set 510 previously generated within the round key control-circuit 500. The key-schedule cache 502 is configured to store at least one key schedule 504 and may store multiple key schedules 504.

In the case of a processor executing a single round key request instruction, a cipher key 511 or other key-word set 510 is received with a round key request instruction 506 requesting a next round key 508 and the round key control-circuit 500 returns the next round key 508. The next round key 508 may be read from the key-schedule cache 502, if available. In this regard, the round key control-circuit 500 includes a comparator circuit 516 that receives the key-word set 510 and determines whether the next round key 508 is stored in the key-schedule cache 502 by, for example, comparing at least a portion of the received key-word set 510 to at least a portion of key words stored in at least one cache entry 512. The comparator circuit 516 may compare the at least one portion of the key-word set 510 to all of the key-word sets 510 stored in the cache entries 512 in the key-schedule cache 502. The comparator circuit 516 receives stored key words from the cache entries 512 over a data bus CE OUT in FIG. 5. The details of cache management for controlling access to the cache entries 512 and providing the key words to the comparator circuit 516 for comparison to the key-word set 510 is design dependent, and may depend on a type of cache employed for the key-schedule cache 502. The comparator circuit 516 may compare all of the key-word set 510 to cache entries 512 of the key-schedule cache 502. The comparator circuit 516 may initially compare only a portion of the key-word set 510 to cache entries 512.

The comparator circuit 516 is also configured generate a hit/miss indication H/M indicating whether the key-word set 510 is stored in the key-schedule cache 502. If the comparator circuit 516 determines the received key-word set 510 is stored in the key-schedule cache 502, the round key control-circuit 500 generates the hit/miss indication H/M, which is provided to a valid key indication circuit 518. In response to the hit/miss indication HIM, the valid key indication circuit 518 determines whether the next round key 508, based on the received key-word set 510, is also stored in the key-schedule cache 502. In this regard, the round key control-circuit 500 further includes a valid key indicator 520 indicating whether target cache entries 512 of the key-schedule cache 502 contain a valid round key 508. The target cache entry 512 is the location in which the next round key 508 should be stored, if the next round key 508 is stored in the key-schedule cache 502. And if the next round key 508 is stored in the key-schedule cache 502, the next round key 508 is supplied to the processor 501 by a next round key circuit 522 on a next round key output NXT_RND_KEY.

in one example, in response to the hit/miss indication H/M indicating the key-word set 510 is stored in the key-schedule cache 502, the valid key indication circuit 518 determines that the key-word set 510 stored in the key-schedule cache 502 is valid based on a valid key indicator 520 corresponding to the cache entry 512 in which the key-word set 510 is stored.

In some examples, the round key request instruction 506 includes an indication of a round number RN. For example, the cipher key 511 may be provided as the key-word set 510 with a request for the next round key 508, and the round number RN indicates a target cache entry 512 where the next round key 508 may be stored based on a cache entry 512 containing the cipher key 511 (“cipher key cache entry 512”). For example, the round number RN may be used as an index of cache entries 512 (e.g., from the cipher key cache entry 512) or as an index of the key-word sets 510 stored in the key-schedule cache 502. The next round key circuit 522 can determine whether the key-word set 510, received in association with the round key request instruction 506, is stored in the key-schedule cache 502 based on the valid key indicator 520 corresponding to the target cache entry 512 for the cipher key 511.

In some examples, the round number RN indicates at least one cache entry 512 in which the key-word set 510 may be stored, and determining whether the key-word set 510 is stored in the key-schedule cache 502 is based on comparing at least a portion of the key-word set 510 to at least a portion of key words (e.g., 2 key words) stored in at least one cache entry 512 indicated by the round number RN. If the key-word set 510 is stored in one of the at least one cache entries 512 indicated by the round number RN, the next round key 508 is stored in a cache entry 512 corresponding to the at least one cache entry 512. Thus, in response to determining that the key-word set 510 is stored in one of the at least one cache entries 512 indicated by the round number RN, the valid key indication circuit 518 checks the valid key indicator 520 associated with the cache entry 512 corresponding to the at least one cache entry 512. The round key control-circuit 500 determines whether the next round key 508 is stored in the key-schedule cache 502 based on the valid key indicator 520 associated with the cache entry 512 corresponding to the at least one cache entry 512.

In some examples, the key-word set 510 is the cipher key 511, and the cipher key 511 is stored in a first one of the cache entries 512. In this example, determining whether the next round key 508 is stored in the key-schedule cache 502 is based on the valid key indicator 510 corresponding to a target cache entry 512, where the target cache entry 512 is indicated by the first one of the cache entries 512 and the round number RN.

The location of the target cache entry 512 may also be determined by a location of a cache entry 512 containing key words of the key-word set 510, or may be determined by another aspect of the request instruction 506 (e.g., request instruction type) that indicates the particular round of the block cipher for which the round key 508 is needed. A key-word set 510 associated with the request for a next round key 508 might not be a cipher key 511. The comparator circuit 516 may determine that the key-word set 510 is stored in a first cache entry 512. or may determine that a last portion (e.g., last two key words) of the key-word set 510 is stored in the first cache entry 512. In this example, all or a portion of the next round key 508 is stored in a target cache entry 512 adjacent to (e.g., next cache entry 512 after or before in the order of generating key-word sets 510) the first cache entry 512. Thus, determining whether the next round key 508 is stored in the key-schedule cache 502 is based on the valid key indicator 520 corresponding to the target cache entry 512 adjacent to the first cache entry 512. In FIG. 5, the valid key indicators 520 are set by the VAL_SET signal and the outputs of the valid key indicators 520 are coupled to the valid key indication circuit 518 as signal VAL_IND. Thus, for example, ten (10) consecutive valid key indicators 520 sequential to a cache entry 512 in which a cipher key 511 is stored may indicate that an entire key schedule 504 of an AES-128 block cipher is stored in the key-schedule cache 502.

in association with or within the round key request instruction 506, the next round key circuit 522 may also include an encryption/decryption indicator ENC_DEC (“ENC_DEC indicator”) indicating whether a data block is being encrypted or decrypted. For example, the ENC_ DEC indicator may be employed to determine, in the case of a request instruction 506 requesting all round keys 508 of a key schedule 504, whether the round keys 508 are provided sequentially in the order in which the round keys 508 are generated by the key expansion algorithm (for encryption), or in the reverse order (for decryption). In another example, the ENC_DEC indicator may be employed to determine whether a single requested round key 508 is in a key-word set 510 generated before or after the received key-word set 510 according to a key expansion algorithm of the block cipher. In this regard, in the case of the ENC_DEC indicator indicating encryption, determining whether the next round key 508 is stored in the key-schedule cache 502 is based on the valid key indicator 520 of a cache entry 512 for storing a round key 508 generated from the key-word set 510 according to a key expansion algorithm of the block cipher. In the case of the ENC_DEC indicator indicating decryption, determining whether the next round key 508 is stored in the key-schedule cache 502 is based on the valid key indicator 520 of a cache entry 512 for storing a round key 508 generated before the (received) key-word set 510 according to a key expansion algorithm of the block cipher.

In the case of a request instruction 506 requesting all round keys 508 of a key schedule 504, the received key-word set 510 is the cipher key 511 of the key schedule 504. In addition, an ENC_DEC indicator may also be received. In the case in which the ENC_DEC indicator indicates encryption, the requested next round key 508 is the first round key 508 of the key schedule 504 based on the cipher key 511. In this case, the next round key 508 and the remaining round keys 508 of the key schedule 504 (generated based on the next round key 508) are sequentially supplied to the processor 501 on the next round key output NXT_RND_KEY. That is, for each of the remaining round keys 508 of the key-schedule cache 502 based on the first round key 508, in the order of round key 508 generation, the round key control-circuit 500 determines whether the round key 508 is stored in the key-schedule cache 502, and in response to determining the round key 508 is stored in the key-schedule cache 502, reads the round key 508 from the key-schedule cache 502. In response to determining the round key 508 is not stored in the key-schedule cache 502, a next round key circuit 522 generates the round key 508 and stores the round key 508 in the key-schedule cache 502. Each round key 508, whether read from the key-schedule cache 502 or generated in the next round key circuit 522, is supplied to the next round key output NXT_RND_KEY.

In the case of a request instruction 506 requesting all round keys 508 of a key schedule 504 and the ENC_DEC indicator indicating decryption, the requested next round key 508 is a last round key 508 of the key schedule 504 based on the received cipher key 511. Before supplying the last round key 508 to the next round key output NXT_RND_KEY, the next round key circuit 522 determines whether all the round keys 508 of the key schedule 504 based on the cipher key 511 are stored in the key-schedule cache 502 based on the valid key indicators 520 corresponding to the cache entries 512 for the round keys 508 of the key schedule 504. The next round key circuit 522 sequentially generates (or requests generation of) round keys 508 not stored in the key-schedule cache 502, and supplies the round keys 508, from the last round key 508 of the key schedule 504 to the cipher key 511 in an order reverse to the order of round key 508 generation, to the next round key output NXT_RND_KEY.

With further reference to FIG. 5, the next round key circuit 522 includes a read control circuit 52.4 configured to read the next round key 508 from (e.g., the target cache entry 512 of) the key-schedule cache 502 in response to determining the next round key 508 is stored in the key-schedule cache 502. The next round key circuit 522. determines the next round key 508 is stored in the key-schedule cache 502 based on the hit/miss indication H/M indicating that the key-word set 510 received with the round key request instruction 506 is stored in the key-schedule cache 502, and the valid key indicator 520 indicating the next round key 508 is stored in the target cache entry 512 of the key-schedule cache 502.

In an example, the comparator circuit 516 is further configured to, in response to the hit/miss indication H/M indicating the received key-word set 510 is stored in the key-schedule cache 502, generate a hit location identifier HIT_ADDR indicating a location of a cache entry 512 in which the received key-word set 510 is stored, and the next round key circuit 522 is further configured to determine a location TGT_ADDR of the target cache entry 512 of the key-schedule cache 502 based on the hit location identifier HIT_ADDR. The next round key circuit 522 generates address and control signals (not shown) to read the target cache entry 512 from the key-schedule cache 502, and receives the next round key 508 from the target cache entry 512 over a data bus DOUT. The address of the target cache entry 512 may be determined based on the hit location identifier HIT_ADDR.

The next round key circuit 522 may be further configured to, in response to the received key-word set 510 received in the comparator circuit 516 being a generated round key of a key schedule 504 (i.e., not a cipher key), determine that the location TGT_ADDR of the target cache entry 512 is the next sequential cache entry 512 following the cache entry location identified by the hit location identifier HIT_ADDR. Alternatively, the next round key circuit 522 may be configured to, in response to the key-word set 510 received by the comparator circuit 516 being a cipher key 511 of the key-schedule cache 502 and the next round key circuit 522 receiving a round number RN included in or accompanying the round key request instruction 506, determine the location TGT_ADDR of the target cache entry 512 based on the hit location identifier HIT_ADDDR and the round number 1214. The valid key indication circuit 518 receives the location TGT_ADDR of the target cache entry 512 and the valid key indicators 520 for the target cache entry 512 and generates an indication TGT_VALID that the target cache entry 512 contains a valid round key 508.

In other words, if the comparator circuit 516 determines the received key-word set 510 is stored in the key-schedule cache 502, and the next round key 508 in the target cache entry 512 is indicated as valid by the corresponding valid key indicator 520, the read control circuit 524 determines the next round key 508 is stored in the key-schedule cache 502 and reads the next round key 508 from target cache entry 512 of the key-schedule cache 502.

On the other hand, if the comparator circuit 516 compares the key-word set 510 to the cache entries 512 (e.g., the cache entries 512 indicated as valid by the corresponding valid key indicators 520) and determines that the key-word set 510 is not stored in the key-schedule cache 502, the next round key circuit 522 generates the next round key 508. Generating the next round key 508 includes generating, based on the key expansion algorithm corresponding to the block cipher, at least a portion of the next key-word set 510. In response to generating the at least a portion of the next key-word set 510, the next round key circuit 522 stores the at least a portion of the next key-word set 510 in the key-schedule cache 502. Storing the next round key 508 in the key-schedule cache 502 includes storing the next key-word set 510 in the key-schedule cache 502. Additionally, if the comparator circuit 516 determines the key-word set 510 is stored in the key-schedule cache 502, but the valid key indication circuit 518 determines that the next round key 508 is not stored in the key-schedule cache 502, the next round key circuit 522 generates the next round key 508 and stores the next round key 508 in the key-schedule cache 502. In either of such circumstances, the next round key circuit 522 includes a key generation circuit 526 that generates a next round key 508 from the cipher key 511 or the key-word set 510 received with the round key request instruction 506 or from the last generated key-word set 510 in response to an all rounds request. The next round key circuit 522 either reads or generates the next round key 508 requested in the round key request instruction 506 and supplies the next round key 508 to the next round key output NXT_RND_KEY. The next round key circuit 522 includes a state machine 528 to control sequential operations such as sequentially supplying the round keys 508 to the processor 501 in response to a request instruction 506 requesting all round keys 508 of a key schedule 504. 100531 With continued reference to FIG. 5, in response to the key generation circuit 526 generating the next round key 508, the next round key circuit 522 stores the generated next round key 508 into the target cache entry 512 of the key-schedule cache 502 by way of a data bus DLN. In addition, the valid key indication circuit 518 sets the valid key indicator 520 corresponding to the target cache entry 512 to indicate the next round key 508 is stored in the target cache entry 512. In one example, the key generation circuit 526 may interface to a round key generation engine that is external to the round key control-circuit 500 with the next round key circuit 522 controlling the interface. In such example, the key generation circuit 526 shown in FIG. 5 would not include the round key generation engine. In one example, the processor 501 is the round key generation engine.

As noted above, in the example of the AES block ciphers, the key-word sets 510 may be 128, 192, or 256 bits in length, but the round keys 508 for each of these block ciphers is consistent at 128 bits (4 key words). Accordingly, an instruction architecture of a processor may include round key request instructions 506 containing key-word sets 510 of varying lengths. In one example, the cache entries 512 are each 128 bits and store one round key 508. In another example, the cache entries 512 may each store one key-word set 510 with a length depending on the block cipher. To support key schedules 504 of different lengths, the next round key circuit 522 is configured for appropriate addressing and data management of different block ciphers. The width and controls of the comparator circuit 516 depend on supported block ciphers. In addition, the valid key indicators 520 would be adjusted depending on cache organization.

According to the example in FIG. 5, the round key control-circuit 500 of FIG. 5 includes the key-schedule cache 502 to store the at least one key schedule 504, and the comparator circuit 516 to receive the key-word set 510 and determine whether the key-word set 510 is stored in the key-schedule cache 502. The valid key indication circuit 518 determines whether the next round key 508 is stored in the key-schedule cache 502, and the next round key circuit 522 can read the next round key 508 from the key-schedule cache 502 or generate the next round key 508 based on the key-word set 510 and supply the next round key 508 to the next round key output NXT_RIND_KEY. However, the structure in FIG. 5 is only one non-limiting example for implementing the inventive aspects disclosed herein. The round key control-circuit 500 may be implemented in hardware logic circuits and storage elements formed of transistors and other electronic components on an integrated circuit, for example.

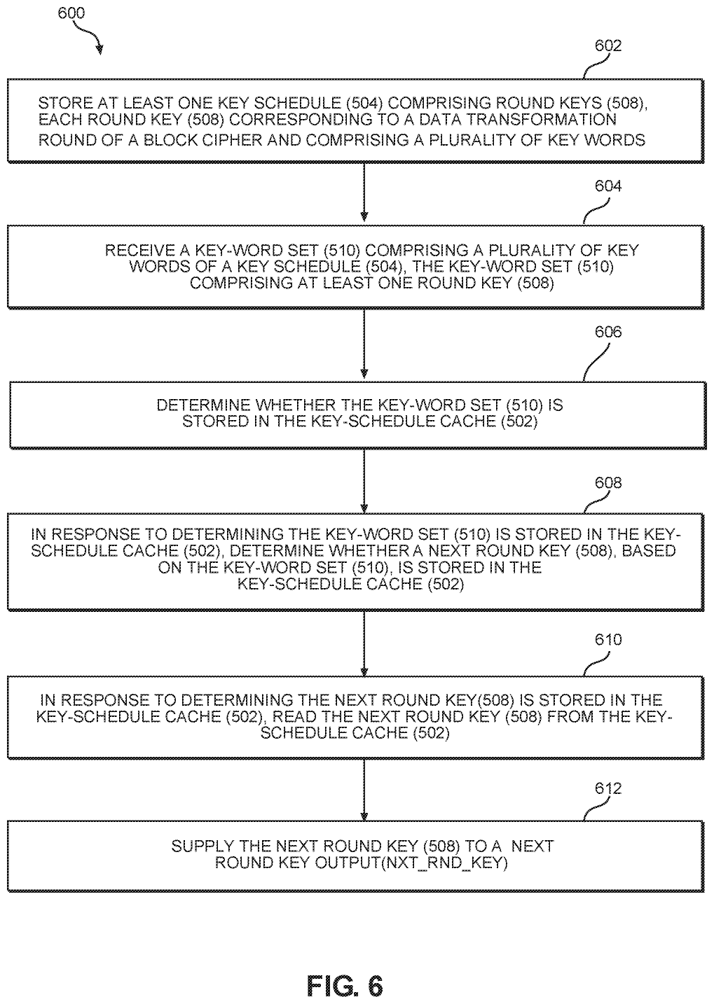

FIG. 6 is flowchart of an exemplary method 600 of the round key control-circuit 500 in FIG. 5 including storing at least one key schedule 504 comprising round keys 508, each round key 508 corresponding to a data transformation round of a block cipher and comprising a plurality of key words (block 602), receiving the key-word set 510 comprising a plurality of key words of the key schedule 504, the key-word set 510 comprising at least one round key 508 (block 604), and determining whether the key-word set 510 is stored in the key-schedule cache 502 (block 606), The method 600 further includes, in response to determining the key-word set 510 is stored in the key-schedule cache 502, determining whether a next round key 508, based on the key-word set 510, is stored in the key-schedule cache 502. (block 608), and, in response to determining the next round key 508 is stored in the key-schedule cache 502, reading the next round key 508 from the key-schedule cache 502 (block 610). The method 600 also includes supplying the next round key 508 to a next round key output NXT_RIND_KEY (block 612).

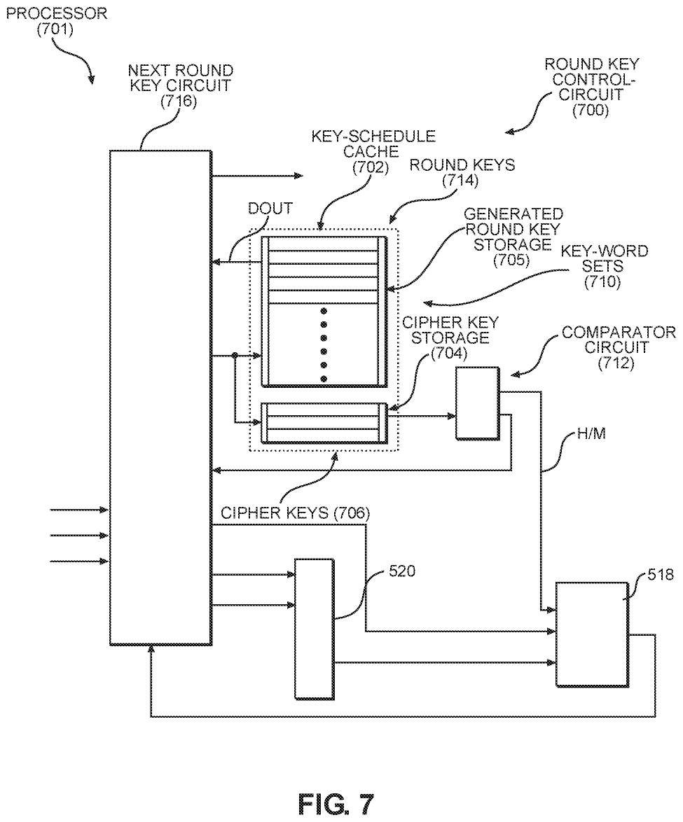

FIG. 7 is a schematic diagram of an exemplary round key control-circuit 700 in a processor 701, wherein a key-schedule cache 702 includes a cipher key storage 704 for storing cipher keys 706 separate from a generated round key storage 705 for storing generated key-word sets 710 to reduce a number of comparisons required by a comparator circuit 712 to determine whether a cipher key 706 is stored in the key-schedule cache 702. Aspects of FIG. 7 having similar functions to corresponding aspects of FIG. 5 are not discussed further here. The round key control-circuit 700 in FIG. 7 is a modification of the round key control-circuit 500 in FIG. 5 specifically for use in conjunction with an instruction architecture in which round key request instructions include a request for all round keys 714 of a key schedule. In this example, round key control-circuit 700 includes the key-schedule cache 702 configured to store generated round keys of at least one key schedule. The key-schedule cache 702 includes the cipher key storage 704 configured to store a cipher key of each of the at least one key schedule and the generated round key storage 708. The comparator circuit 712 receives a cipher key 706 for a first data transformation round in the block cipher, determines whether the cipher key 706 is stored in the cipher key storage 704, and generates a hit/miss indication H/M indicating whether the cipher key 706 is stored in the cipher key storage 704. The round key control-circuit 700 includes the valid key indication circuit 518 and the valid key indicators 520 in the round key control-circuit 500 in FIG. 5 and a next round key circuit 716 to control the separate cipher key storage 704.

A round key control-circuit in an encryption/decryption system configured to store at least one key schedule including a cipher key and round keys generated based on the cipher key, and supply a next round key stored in the key-schedule cache to a processor to avoid wasting processor capacity and power consumption required to regenerate round keys of the key schedule from the same cipher key, such as the round key control-circuit in FIGS. 5 and 7, and according to any aspects disclosed herein, may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

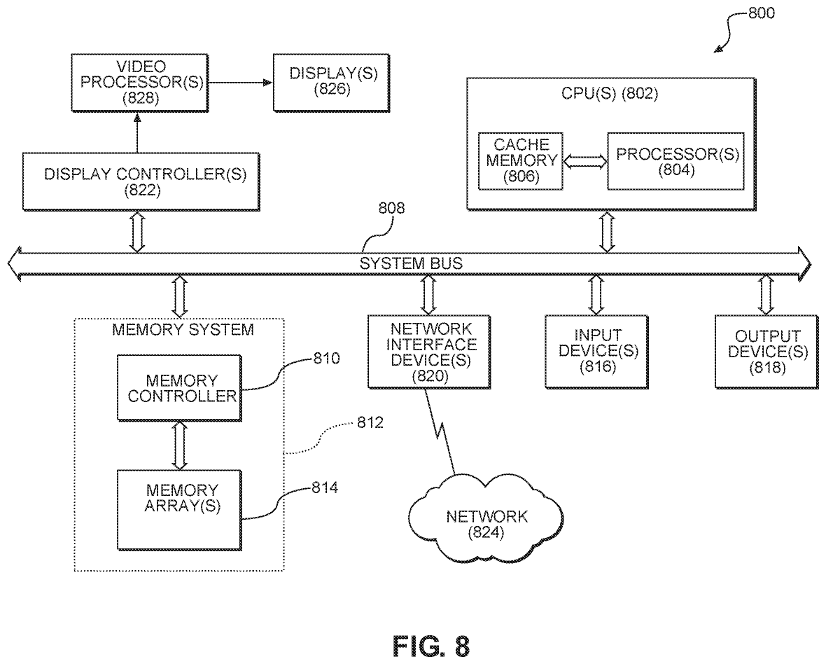

in this regard, FIG. 8 illustrates an example of a processor-based system 800 including a round key control-circuit in an encryption/decryption system configured to store at least one key schedule including a cipher key and round keys generated based on the cipher key, and supply a next round key stored in the key-schedule cache to a processor to avoid wasting processor capacity and power consumption required to regenerate round keys of the key schedule from the same cipher key, such as the round key control-circuit in FIGS. 5 and 7, and according to any aspects disclosed herein. In this example, the processor-based system 800 includes one or more central processor units (CPUs) 802, which may also be referred to as CPU or processor cores, each including one or more processors 804. The CPU(s) 802 may have cache memory 806 coupled to the processor(s) 804 for rapid access to temporarily stored data. As an example, the processor(s) 804 could include a round key control-circuit in an encryption/decryption system configured to store at least one key schedule including a cipher key and round keys generated based on the cipher key, and supply a next round key stored in the key-schedule cache to a processor to avoid wasting processor capacity and power consumption required to regenerate round keys of the key schedule from the same cipher key, such as the round key control-circuit in FIGS. 5 and 7, and according to any aspects disclosed herein. The CPU(s) 802 is coupled to a system bus 808 and can intercouple master and slave devices included in the processor-based system 800. As is well known, the CPU(s) 802 communicates with these other devices by exchanging address, control, and data information over the system bus 808. For example, the CPU(s) 802 can communicate bus transaction requests to a memory controller 810 as an example of a slave device. Although not illustrated in FIG. 8, multiple system buses 808 could be provided, wherein each system bus 808 constitutes a different fabric.

Other master and slave devices can be connected to the system bus 808. As illustrated in FIG. 8, these devices can include a memory system 812 that includes the memory controller 810 and one or more memory arrays 814, one or more input devices 816, one or more output devices 818, one or more network interface devices 820, and one or more display controllers 822, as examples. Each of the memory system 812, the one or more input devices 816, the one or more output devices 818, the one or more network interface devices 820, and the one or more display controllers 822 can include a round key control-circuit in an encryption/decryption system configured to store at least one key schedule including a cipher key and round keys generated based on the cipher key, and supply a next round key stored in the key-schedule cache to a processor to avoid wasting processor capacity and power consumption required to regenerate round keys of the key schedule from the same cipher key, such as the round key control-circuit in FIGS. 5 and 7, and according to any aspects disclosed herein. The input device(s) 816 can include any type of input device, including, but not limited to, input keys, switches, voice processors, etc. The output device(s) 818 can include any type of output device, including, but not limited to, audio, video, other visual indicators, etc. The network interface device(s) 820 can be any device configured to allow exchange of data to and from a network 824. The network 824 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 820 can be configured to support any type of communications protocol desired.

The CPU(s) 802 may also be configured to access the display controller(s) 822 over the system bus 808 to control information sent to one or more displays 826. The display controller(s) 822 sends information to the display(s) 826 to be displayed via one or more video processors 828, which process the information to be displayed into a format suitable for the displays) 826. The display(s) 826 can include any type of display, including, but not limited to, a cathode ray tube (CRT), a liquid crystal display (LCD), a plasma display, a light emitting diode (LED) display, etc. The display controller(s) 822, display(s) 826, and/or the video processor(s) 828 can include a round key control-circuit in an encryption/decryption system configured to store at least one key schedule including a cipher key and round keys generated based on the cipher key, and supply a next round key stored in the key-schedule cache to a processor to avoid wasting processor capacity and power consumption required to regenerate round keys of the key schedule from the same cipher key, such as the round key control-circuit in FIGS. 5 and 7, and according to any aspects disclosed herein.

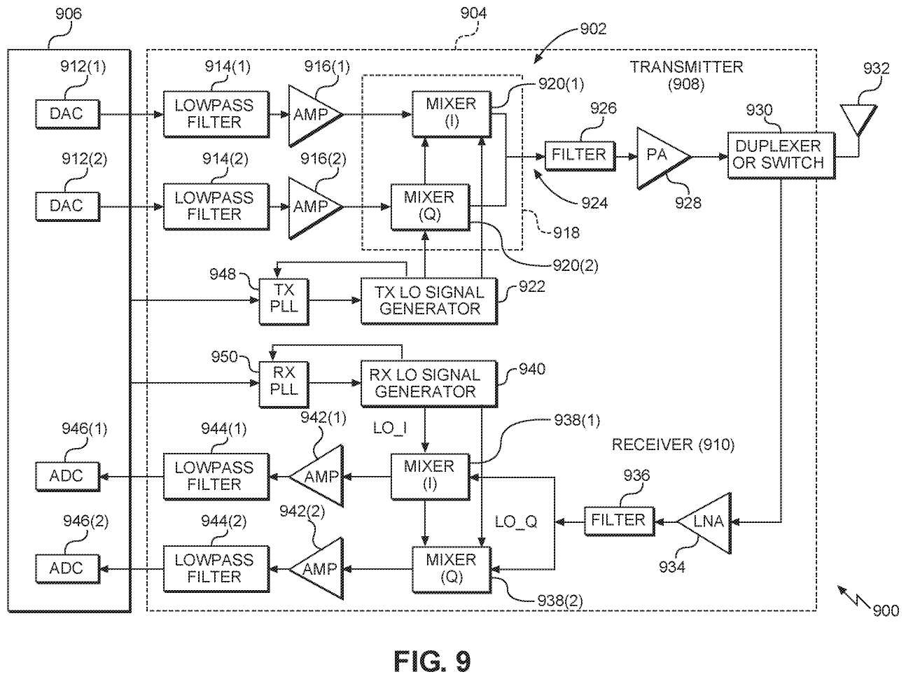

FIG. 9 illustrates an exemplary wireless communications device 900 that includes radio frequency (RF) components formed from an integrated circuit (IC) 902, wherein any of the components therein can include a round key control-circuit in an encryption/decryption system configured to store at least one key schedule including a cipher key and round keys generated based on the cipher key, and supply a next round key stored in the key-schedule cache to a processor to avoid wasting processor capacity and power consumption required to regenerate round keys of the key schedule from the same cipher key, such as the round key control-circuit in FIGS. 5 and 7, and according to any aspects disclosed herein. The wireless communications device 900 may include or be provided in any of the above-referenced devices, as examples. As shown in FIG. 9, the wireless communications device 900 includes a transceiver 904 and a data processor 906. The data processor 906 may include a memory to store data and program codes. The transceiver 904 includes a transmitter 908 and a receiver 910 that support bi-directional communications. in general, the wireless communications device 900 may include any number of transmitters 908 and/or receivers 910 for any number of communication systems and frequency bands. All or a portion of the transceiver 904 may be implemented on one or more analog ICs, RF ICs (RFICs), mixed-signal ICs, etc.

The transmitter 908 or the receiver 910 may be implemented with a super-heterodyne architecture or a direct-conversion architecture. In the super-heterodyne architecture, a signal is frequency-converted between RF and baseband in multiple stages, e.g., from RF to an intermediate frequency (IF) in one stage, and then from IF to baseband in another stage for the receiver 910. In the direct-conversion architecture, a signal is frequency-converted between RF and baseband in one stage. The super-heterodyne and direct-conversion architectures may use different circuit blocks and/or have different requirements. In the wireless communications device 900 in FIG. 9, the transmitter 908 and the receiver 910 are implemented with the direct-conversion architecture.

In the transmit path, the data processor 906 processes data to be transmitted and provides I and Q analog output signals to the transmitter 908. In the exemplary wireless communications device 900, the data processor 906 includes digital-to-analog converters (DACs) 912(1), 912(2) for converting digital signals generated by the data processor 906 into the I and Q analog output signals, e.g., I and Q output currents, for further processing.

Within the transmitter 908, lowpass filters 914(1), 914(2) filter the I and Q analog output signals, respectively, to remove undesired signals caused by the prior digital-to-analog conversion. Amplifiers (AMPs) 916(1), 916(2) amplify the signals from the lowpass filters 914(1), 914(2), respectively, and provide I and Q baseband signals. An upconverter 918 upconverts the I and Q baseband signals with I and Q transmit (TX) local oscillator (LO) signals through mixers 920(1), 920(2) from a TX LO signal generator 922 to provide an upconverted signal 924. A filter 926 filters the upconverted signal 924 to remove undesired signals caused by the frequency upconversion as well as noise in a receive frequency band. A power amplifier (PA) 928 amplifies the upconverted signal 924 from the filter 926 to obtain the desired output power level and provides a transmitted RF signal. The transmitted RF signal is routed through a duplexer or switch 930 and transmitted via an antenna 932.

In the receive path, the antenna 932 receives signals transmitted by base stations and provides a received RF signal, which is routed through the duplexer or switch 930 and provided to a low noise amplifier (LNA) 934. The duplexer or switch 930 is designed to operate with a specific receive (RX)-to-TX duplexer frequency separation, such that RX signals are isolated from TX signals. The received RF signal is amplified by the LNA 934 and filtered by a filter 936 to obtain a desired RF input signal. Downconversion mixers 938(1), 938(2) mix the output of the filter 936 with I and Q RX LO signals (i.e., LO_I and LO_Q) from an RX LO signal generator 940 to generate I and Q baseband signals. The I and Q baseband signals are amplified by amplifiers (AMPs) 942(1), 942(2) and further filtered by lowpass filters 944(1), 944(2.) to obtain I and Q analog input signals, which are provided to the data processor 906. In this example, the data processor 906 includes analog-to-digital converters (ADCs) 946(1), 946(2) for converting the analog input signals into digital signals to be further processed by the data processor 906.

In the wireless communications device 900 of FIG. 9, the TX LO signal generator 922 generates the I and Q TX LO signals used for frequency upconversion, while the RX L( )signal generator 940 generates the I and Q RX L(i) signals used for frequency downconversion. Each LO signal is a periodic signal with a particular fundamental frequency. A TX phase-locked loop (PLL) circuit 948 receives timing information from the data processor 906 and generates a control signal used to adjust the frequency and/or phase of the TX L( )signals from the TX L(I) signal generator 922. Similarly, an RX PLL circuit 950 receives timing information from the data processor 906 and generates a control signal used to adjust the frequency and/or phase of the RX LO signals from the RX LO signal generator 940.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master and slave devices described herein may be employed in any circuit, hardware component, IC, or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also he implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein but, is to be accorded the widest scope consistent with the principles and novel features disclosed herein.

What is claimed is:

1. A round key control-circuit configured to:
store at least one key schedule comprising round keys, each round key corresponding to a data transformation round of a block cipher and comprising a plurality of key words;
receive a key-word set comprising a plurality of key words of a key schedule, the key-word set comprising at least one round key;
determine whether the key-word set is stored in a key-schedule cache; and
in response to determining the key-word set is stored in the key-schedule cache:
determine whether a next round key, based on the key-word set, is stored in the key-schedule cache;
in response to determining the next round key is stored in the key-schedule cache, read the next round key from the key-schedule cache; and
supply the next round key to a next round key output.

2. The round key control-circuit of claim 1, further configured to:
in response to determining the key-word set is not stored in the key-schedule cache, generate the next round key based on the key-word set;
in response to determining the next round key is not stored in the key-schedule cache, generate the next round key based on the key-word set; and
supply the next round key to the next round key output.

3. The round key control-circuit of claim 1, further configured to:
in response to determining the key-word set is not stored in the key-schedule cache, store the key-word set in the key-schedule cache; and
in response to generating the next round key:
store the next round key in the key-schedule cache: and
supply the next round key to a next round key output.

4. The round key control-circuit of claim 2, further configured to identify a key expansion algorithm based on a number of key words in the received key-word set, wherein:
generating the next round key comprises generating a next key-word set comprising at least a portion of the next round key based on the key expansion algorithm; and
storing the next round key in the key-schedule cache comprises storing the next key-word set in the key-schedule cache.

5. The round key control-circuit of claim 2, further configured to:
receive an instruction comprising the key-word set; and
determine a key expansion algorithm based on the instruction, wherein:
generating the next round key comprises generating a next key-word set comprising at least a portion of the next round key based on the key expansion algorithm; and
storing the next round key in the key-schedule cache comprises storing the next key-word set in the key-schedule cache.

6. The round key control-circuit of claim I, further configured to receive an instruction comprising the key-word set, the instruction further comprising a request for the next round key.

7. The round key control-circuit of claim 6, wherein:
determining whether the key-word set is stored in the key-schedule cache is based on comparing at least a portion of the key-word set to at least a portion of key words stored in at least one cache entry,

8. The round key control-circuit of claim 6, wherein:
the instruction further comprises an indication of a round number of the block cipher;
determining whether the key-word set is stored in the key-schedule cache is based on comparing at least a portion of the key-word set to at least a portion of key words stored in at least one cache entry indicated by the round number; and
in response to determining the key-word set is stored in a first one of the at least one cache entry indicated by the round number, determining whether the next round key is stored in the key-schedule cache is based on a valid key indicator corresponding to a second cache entry corresponding to the first one of the at least one cache entry.

9. The round key control-circuit of claim 7, wherein:
the instruction further comprises an indication of a round number of the block cipher;
the key-word set comprises a cipher key;
the cipher key is stored in a first cache entry; and
determining whether the next round key is stored in the key-schedule cache is based on a valid key indicator corresponding to a target cache entry indicated by the first cache entry and the round number.

10. The round key control-circuit of claim 9, wherein:
the instruction further comprises an encryption/decryption indicator;
the encryption/decryption indicator indicates encryption; and
determining whether the next round key is stored in the key-schedule cache is based on the valid key indicator of a cache entry for storing a subsequent round key in an encryption order according to a key expansion algorithm of the block cipher.

11. The round key control-circuit of claim 9, wherein:
the instruction further comprises an encryption/decryption indicator;
the encryption/decryption indicator indicates decryption; and
determining whether the next round key is stored in the key-schedule cache is based on the valid key indicator of a cache entry for storing a subsequent round key in a decryption order according to a key expansion algorithm of the block cipher.

12. The round key control-circuit of claim 1, further configured to:
receive an instruction comprising the key-word set, a request for all round keys of the key schedule, and an encryption/decryption indicator.

13. The round key control-circuit of claim 12, wherein:
the key schedule is based on a cipher key;
the key-word set comprises the cipher key;
in response to determining the key-word set is not stored in the key-schedule cache, store the cipher key in the key-schedule cache; and
in response to the encryption/decryption indicator indicating encryption, the round key control-circuit is further configured to:
for each round key of the key schedule based on the cipher key, in an order of round key generation, the round key control-circuit is further configured to:
determine whether the round key is stored in the key-schedule cache;
in response to determining the round key is stored in the key-schedule cache, read the round key from the key-schedule cache;
in response to determining the round key is not stored in the key-schedule cache, generate the round key and store the round key in the key-schedule cache; and
supply the round key to the next round key output.

14. The round key control-circuit of claim 12, further configured to receive an indication of a round number of the block cipher; wherein:
determining whether the key-word set is stored in the key-schedule cache is based on comparing at least a portion of the key-word set to at least a portion of key words stored in at least one cache entry indicated by the round number;
in response to determining the key-word set is not stored in the key-schedule cache, store the key-word set in the key-schedule cache; and
in response to the encryption/decryption indicator indicating encryption, the round key control-circuit is further configured to:
for each round key of the key schedule based on a cipher key, in an order of round key generation starting with the next round key indicated by the round number, the round key control-circuit is further configured to:
determine whether the round key is stored in the key-schedule cache;
in response to determining the round key is stored in the key-schedule cache, read the round key from the key-schedule cache;
in response to determining the round key is not stored in the key-schedule cache, generate the round key and store the round key in the key-schedule cache; and
supply the round key to the next round key output.

15. The round key control-circuit of claim 1, further comprising:
the key-schedule cache configured to store the at least one key schedule;
a comparator circuit configured to:
receive the key-word set; and
determine whether the key-word set is stored in the key-schedule cache;
a valid key indication circuit configured to determine whether the next round key is stored in the key-schedule cache; and
a next round key circuit configured to:
in response to determining the round key is stored in the key-schedule cache, read the next round key from the key-schedule cache;
in response to determining the round key is not stored in the key-schedule cache, generate the next round key based on the key-word set; and
supply the next round key to the next round key output.

16. The round key control-circuit of claim 1 integrated in an integrated circuit (IC).

17. The round key control-circuit of claim 1, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

18. A method of a round key control-circuit, the method comprising:
storing at least one key schedule comprising round keys, each round key corresponding to a data transformation round of a block cipher and comprising a plurality of key words;
receiving a key-word set comprising a plurality of key words of a key schedule, the key-word set comprising at least one round key;
determining whether the key-word set is stored in a key-schedule cache;
in response to determining the key-word set is stored in the key-schedule cache, determining whether a next round key, based on the key-word set, is stored in the key-schedule cache;
in response to determining the next round key is stored in the key-schedule cache, reading the next round key from the key-schedule cache; and
supplying the next round key to a next round key output.

19. The method of claim 18, further comprising:
in response to determining the key-word set is not stored in the key-schedule cache, generating the next round key based on the key-word set; and
in response to determining the next round key is not stored in the key-schedule cache, generating the next round key based on the key-word set.

20. The method of claim 18, further comprising:
in response to determining the key-word set is not stored in the key-schedule cache, storing the key-word set in the key-schedule cache; and
in response to generating the next round key, storing the next round key in the key-schedule cache.

21. The method of claim 20, further comprising identifying the block cipher based on a number of key words in the received key-word set, wherein:
generating the next round key further comprises generating a next key-word set comprising at least a portion of the next round key based on a key expansion algorithm corresponding to the block cipher; and
storing the next round key in the key-schedule cache further comprises storing the next key-word set in the key-schedule cache.

22. The method of claim 19, further comprising:
receiving an instruction comprising the key-word set; and
determining a key expansion algorithm based on the instruction, wherein:
generating the next round key further comprises generating a next key-word set comprising at least a portion of the next round key based on the key expansion algorithm; and
storing the next round key in the key-schedule cache further comprises storing the next key-word set in the key-schedule cache.

23. The method of claim 19, further comprising receiving an instruction comprising the key-word set, the instruction further comprising a request for the next round key.

24. The method of claim 23, wherein:
determining whether the key-word set is stored in the key-schedule cache is based on comparing at least a portion of the key-word set to at least a portion of key words stored in at least one cache entry.

25. The method of claim 24, wherein:
the instruction further comprises an indication of a round number of the block cipher;
the round number indicates a target cache entry for storing the next round key based on a cipher key cache entry storing at least a portion of a cipher key; and
determining whether the next round key is stored in the key-schedule cache is based on a valid key indicator corresponding to the target cache entry.

26. The method of claim 24, wherein:
at least a key word of the key-word set is stored in a first cache entry; and
determining whether the next round key is stored in the key-schedule cache is based on a valid key indicator corresponding to a target cache entry adjacent to the first cache entry.

27. The method of claim 26, wherein:
the instruction further comprises an encryption/decryption indicator;
the encryption/decryption indicator indicates encryption; and
determining whether the next round key is stored in the key-schedule cache is based on the valid key indicator of a cache entry for storing a subsequent round key in an encryption order according to a key expansion algorithm of the block cipher.

28. The method of claim 26, wherein:
the instruction further comprises an encryption/decryption indicator;
the encryption/decryption indicator indicates decryption; and
determining whether the next round key is stored in the key-schedule cache is based on the valid key indicator of a cache entry for storing a subsequent round key in a decryption order according to a key expansion algorithm of the block cipher.

29. The method of claim 18, further comprising:
receiving an instruction comprising the key-word set, a request for all round keys of the key schedule, and an encryption/decryption indicator.

30. The method of claim 29, wherein:
the key schedule is based on a cipher key;
the key-word set comprises the cipher key;
in response to determining the key-word set is not stored in the key-schedule cache, storing the cipher key in the key-schedule cache; and
the round key control-circuit is further configured to, in response to the encryption/decryption indicator indicating encryption:
for each round key of the key schedule based on the cipher key, in an order of round key generation, the round key control-circuit is further configured to:
determine whether the round key is stored in the key-schedule cache;
in response to determining the round key is stored in the key-schedule cache, read the round key from the key-schedule cache;
in response to determining the round key is not stored in the key-schedule cache, generate the round key and store the round key in the key-schedule cache; and
supply the round key to the next round key output.

31. The method of claim 29, further configured to receive an indication of a round number of the block cipher, wherein:
determining whether the key-word set is stored in the key-schedule cache is based on comparing at least a portion of the key-word set to at least a portion of key words stored in at least one cache entry indicated by the round number;
in response to determining the key-word set is not stored in the key-schedule cache, store the key-word set in the key-schedule cache; and
in response to the encryption/decryption indicator indicating encryption, the round key control-circuit is further configured to:
for each round key of the key schedule based on a cipher key, in an order of round key generation starting with the next round key indicated by the round number, the round key control-circuit is further configured to:
determine whether the round key is stored in the key-schedule cache;
in response to determining the round key is stored in the key-schedule cache, read the round key from the key-schedule cache;
in response to determining the round key is not stored in the key-schedule cache, generate the round key and store the round key in the key-schedule cache; and
supply the round key to the next round key output.

32. A processor circuit, comprising:
a key-schedule cache; and
a round key control-circuit, configured to:
store at least one key schedule in the key-schedule cache, the at least one key schedule comprising round keys, each round key corresponding to a data transformation round of a block cipher and comprising a plurality of key words;
receive a key-word set comprising a plurality of key words of a key schedule, the key-word set comprising at least one round key;
determine whether the key-word set is stored in the key-schedule cache;
in response to determining the key-word set is stored in the key-schedule cache, determine whether a next round key, based on the key-word set, is stored in the key-schedule cache;
in response to determining the next round key is stored in the key-schedule cache, read the next round key from the key-schedule cache; and
supply the next round key to a next round key output.
